(19) United States
(12) Patent Application Publication
(10) Pub. No.: US 2026/0300889 A1
(43) Pub. Date: Oct. 1, 2026

(54) METHOD AND SYSTEM FOR ARTIFICIAL INTELLIGENCE INFUSED CALL AUDIT AND COMPILANCE

(71) Applicant: Tata Consultancy Services Limited, Mumbai (IN)

(72) Inventors: Akhil Omprakash HADA, Thane (IN); Prabin Ranjan SAHOO, Thane (IN); Ashutosh MOHANTY, Bhubaneswar (IN); Mayur Arunrao FALE, Nagpur (IN)

(73) Assignee: Tata Consultancy Services Limited, Mumbai (IN)

(21) Appl. No.: 19/632,488

(22) Filed: Mar. 30, 2026

(30) Foreign Application Priority Data
Mar. 29, 2025 (IN) 202521030842

(51) Int. Cl. G06Q 10/0639; G06F 40/166; G06F 40/35; G06F 40/40

(52) U.S. Cl. CPC G06Q 10/06398; G06F 40/166; G06F 40/35; G06F 40/40

(57) ABSTRACT

Automatically and intelligently selecting right sample of calls from among a huge pool of available call transcripts and enabling easy scaling for handling ever increasing volume of calls for call auditing and compliance is hardly focused upon in the existing methods, even with use of AI based approaches. Sampling of call transcripts is performed to obtain a sample set by performing uniform distribution across the plurality of agents, across time windows recorded for the set of calls within a day, and across length of conversations of the set of calls. Each call transcript within the sample set is validated via ML model to eliminate junk calls. Thus the sample set so created picks appropriate call transcripts that contributes to accurate and effective call quality analysis. A batch withing sample set Is further clustered based on similarity of conversation before analyzed by ML model for compliance scoring of call agent.

### PRIORITY CLAIM

This U.S. patent application claims priority under 35 U.S.C. § 119 to: India Application No. 202521030842, filed on Mar. 29, 2025. The entire contents of the aforementioned application are incorporated herein by reference.

### TECHNICAL FIELD

The embodiments herein generally relate to the field of Artificial Intelligence (AI) in data analysis and insights and, more particularly, to a method and system for AI infused call audit and compliance.

### BACKGROUND

Customer support is one of the critical aspect for business run by an organization. Customer satisfaction with speedy issue resolution over calls is one major part of customer support cell of the organization. Thus, call audit and compliance and business impact of the calls handled by agents of the customer support cell is critical for business. Prioritizing call auditing and compliance can ensure call agents provide high quality customer support while maintaining regulatory adherence and protecting sensitive data.

Artificial Intelligence (AI), Natural Language Processing (NLP) techniques, and GenAI are powerful tools for data analysis and insights. Existing methods have attempted using the above techniques for call analysis for audit and compliance. However, for an audit and compliance check to be accurate and effective many factors need to be considered. Furthermore, considering the volume of calls, analyzing every call is very challenging. Existing methods focus on methods of call quality analysis but have hardly seen to be focusing on call volume challenges. Furthermore, the volume of calls is bound to increase multifold with time. Addressing scalability in approaches proposed for call audit and compliance is another unaddressed technical challenge.

### SUMMARY

Embodiments of the present disclosure present technological improvements as solutions to one or more of the above-mentioned technical problems recognized by the inventors in conventional systems.

For example, in one embodiment, a method for a method and system for AI infused call audit and compliance is provided.

The method includes sourcing a plurality of call transcripts of an organization, recorded for a plurality of calls handled by a plurality of agents with a plurality of customers for a plurality of products.

Further, the method includes sampling the plurality of call transcripts to obtain a sample set by performing uniform distribution across the plurality of agents, across time windows recorded for the set of calls within a day, and across length of conversations of the set of calls. Each call transcript within the sample set is validated via a first pretrained ML model executed by the one or more hardware processors, to eliminate junk calls.

Furthermore, the method includes splitting the sample set in accordance with a predefined batch size to obtain a plurality of batches.

Further, the method includes performing a first level processing of on a subset of call transcripts in each batch from among the plurality of batches to generate a call audit and compliance report for each of the plurality of agents, the first level processing comprising: (i) Clustering, each batch in accordance with a similarity of a conversation among the subset of transcripts to obtain a plurality of clusters per batch, wherein the similarity within each cluster among the plurality of clusters based on a category or subcategory of a product discussed in the conversation from among the plurality of products, an issue associated with the product in the conversation and a customer among the plurality of customers having the conversation. (ii) Validating, via a second pretrained ML model executed by the one or more hardware processors, each of the plurality of agents within each cluster by scoring each call transcript among the subset of call transcripts against a plurality of audit and compliance parameters to classify each of the plurality of agent into a category among a plurality of categories comprising compliant, partially compliant, and non-compliant. (iii) Generating a call audit and compliance report for each of the plurality of agents in accordance with a classified category and specifying one or more of the plurality of audit and compliance parameters scoring below a predefined scoring threshold.

The method further performs a second level processing of each batch to assess critical impact of each call transcript on a business of the organization by: (i) summarizing each call transcript of each cluster via a LLM into a call summary to identify meeting topic, key points discussed and generate future recommendations along with overall call sentiments, (ii) processing the call summary of each of the call transcript of associated cluster among the plurality of clusters via the LLM to review and categorize the call summary for assessing critical impact on the business on the category or the sub-category of the product; and (iii) raising a flag if assessment indicates critical impact on the business on validation against a set of business rules.

In another aspect, a system for a method and system for AI infused call audit and compliance is provided. The system comprises a memory storing instructions; one or more Input/Output (I/O) interfaces; and one or more hardware processors coupled to the memory via the one or more I/O interfaces, wherein the one or more hardware processors are configured by the instructions to source a plurality of call transcripts of an organization, recorded for a plurality of calls handled by a plurality of agents with a plurality of customers for a plurality of products.

Further, the one or more hardware processors are configured to sampling the plurality of call transcripts to obtain a sample set by performing uniform distribution across the plurality of agents, across time windows recorded for the set of calls within a day, and across length of conversations of the set of calls. Each call transcript within the sample set is validated via a first pretrained ML model executed by the one or more hardware processors, to eliminate junk calls.

Furthermore, the one or more hardware processors are configured to split the sample set in accordance with a predefined batch size to obtain a plurality of batches.

Further, the one or more hardware processors are configured to perform a first level processing of on a subset of call transcripts in each batch from among the plurality of batches to generate a call audit and compliance report for each of the plurality of agents, the first level processing comprises: (i) Clustering, each batch in accordance with a similarity of a conversation among the subset of transcripts to obtain a plurality of clusters per batch, wherein the similarity within each cluster among the plurality of clusters based on a category or subcategory of a product discussed in the conversation from among the plurality of products, an issue associated with the product in the conversation and a customer among the plurality of customers having the conversation. (ii) Validating, via a second pretrained ML model executed by the one or more hardware processors, each of the plurality of agents within each cluster by scoring each call transcript among the subset of call transcripts against a plurality of audit and compliance parameters to classify each of the plurality of agent into a category among a plurality of categories comprising compliant, partially compliant, and non-compliant. (iii) Generating a call audit and compliance report for each of the plurality of agents in accordance with a classified category and specifying one or more of the plurality of audit and compliance parameters scoring below a predefined scoring threshold.

Further, the one or more hardware processors are configured to perform a second level processing of each batch to assess critical impact of each call transcript on a business of the organization by: (i) summarizing each call transcript of each cluster via a LLM into a call summary to identify meeting topic, key points discussed and generate future recommendations along with overall call sentiments, (ii) processing the call summary of each of the call transcript of associated cluster among the plurality of clusters via the LLM to review and categorize the call summary for assessing critical impact on the business on the category or the sub-category of the product; and (iii) raising a flag if assessment indicates critical impact on the business on validation against a set of business rules.

In yet another aspect, there are provided one or more non-transitory machine-readable information storage mediums comprising one or more instructions which when executed by one or more hardware processors cause: method for a method and system for AI infused call audit and compliance.

The method includes sourcing a plurality of call transcripts of an organization, recorded for a plurality of calls handled by a plurality of agents with a plurality of customers for a plurality of products.

Further, the method includes sampling the plurality of call transcripts to obtain a sample set by performing uniform distribution across the plurality of agents, across time windows recorded for the set of calls within a day, and across length of conversations of the set of calls. Each call transcript within the sample set is validated via a first pretrained ML model executed by the one or more hardware processors, to eliminate junk calls.

Furthermore, the method includes splitting the sample set in accordance with a predefined batch size to obtain a plurality of batches.

Further, the method includes performing a first level processing of on a subset of call transcripts in each batch from among the plurality of batches to generate a call audit and compliance report for each of the plurality of agents, the first level processing comprising: (i) Clustering, each batch in accordance with a similarity of a conversation among the subset of transcripts to obtain a plurality of clusters per batch, wherein the similarity within each cluster among the plurality of clusters based on a category or subcategory of a product discussed in the conversation from among the plurality of products, an issue associated with the product in the conversation and a customer among the plurality of customers having the conversation. (ii) Validating, via a second pretrained ML model executed by the one or more hardware processors, each of the plurality of agents within each cluster by scoring each call transcript among the subset of call transcripts against a plurality of audit and compliance parameters to classify each of the plurality of agent into a category among a plurality of categories comprising compliant, partially compliant, and non-compliant. (iii) Generating a call audit and compliance report for each of the plurality of agents in accordance with a classified category and specifying one or more of the plurality of audit and compliance parameters scoring below a predefined scoring threshold.

The method further performs a second level processing of each batch to assess critical impact of each call transcript on a business of the organization by: (i) summarizing each call transcript of each cluster via a LLM into a call summary to identify meeting topic, key points discussed and generate future recommendations along with overall call sentiments, (ii) processing the call summary of each of the call transcript of associated cluster among the plurality of clusters via the LLM to review and categorize the call summary for assessing critical impact on the business on the category or the sub-category of the product; and (iii) raising a flag if assessment indicates critical impact on the business on validation against a set of business rules.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles:

FIG. 1A is a functional block diagram of a system Artificial Intelligence (AI) infused call audit and compliance, in accordance with some embodiments of the present disclosure.

FIG. 1B illustrates an architectural overview of the system FIG. 1A depicting overall process flow, in accordance with some embodiments of the present disclosure.

FIGS. 2A and 2B is a flow diagram illustrating a method for AI infused call audit and compliance, using the system depicted in FIGS. 1A and 1B, in accordance with some embodiments of the present disclosure.

FIG. 3 and FIG. 4 depict sample call visual representation of call compliance reports generated by the system, in accordance with some embodiments of the present disclosure.

It should be appreciated by those skilled in the art that any block diagrams herein represent conceptual views of illustrative systems and devices embodying the principles of the present subject matter. Similarly, it will be appreciated that any flow charts, flow diagrams, and the like represent various processes which may be substantially represented in computer readable medium and so executed by a computer or processor, whether or not such computer or processor is explicitly shown.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the scope of the disclosed embodiments.

Embodiments of the present disclosure provide a method and system for AI infused call audit and compliance of calls recorded between call agents and customers of an organization. As mentioned, technical challenge lies in automatic and intelligent selection of right sample of calls from among a huge pool of available call transcripts. Optimal sample selection is critical to accuracy of call quality analysis. Furthermore, it is required that solutions incorporate scalability features where continuous increasing volume of call recordings are incorporated without need of upgrading the implemented call quality analysis system. This ensures economical and efficient systems. Even AI based existing approaches for call quality or call audits, sampling and scalability is hardly addressed. The method herein performs sampling of call transcripts to obtain a sample set by performing uniform distribution across the plurality of agents, across time windows recorded for the set of calls within a day, and across length of conversations of the set of calls. Each call transcript within the sample set is validated via a first pretrained ML model to eliminate junk calls. Thus the sample set so created picks appropriate call transcripts that contributes to accurate and effective call quality analysis.

Furthermore, prior to processing for call audit and compliance each batch within the sample set is clustered in accordance with a similarity of a conversation such a category or subcategory of a product discussed in the conversation from among the plurality of products, an issue associated with the product in the conversation and a customer among the plurality of customers having the conversation. The clustering so formed provides a context of similarity within the call transcripts to ML models and LLM during further analysis, resulting in more relevant outcome.

With use of AI models such as conventional ML models and Large Language Models (LLMs), the method disclosed provides time efficient and scalable approach for call audit and compliance analysis for continuous flow of huge volumes of call recordings. The call audit and compliance report generated across a set of call quality parameters per individual (call agent) at frequent intervals enables comparison and recommendation to the individual for performance improvement.

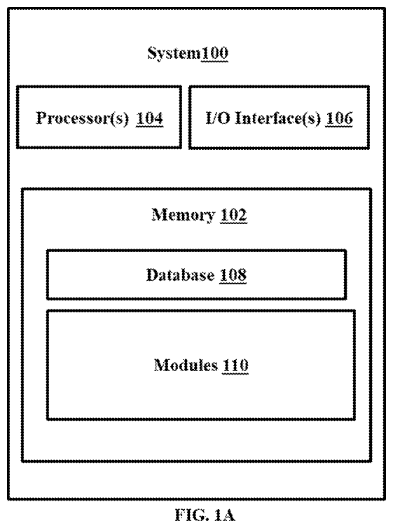

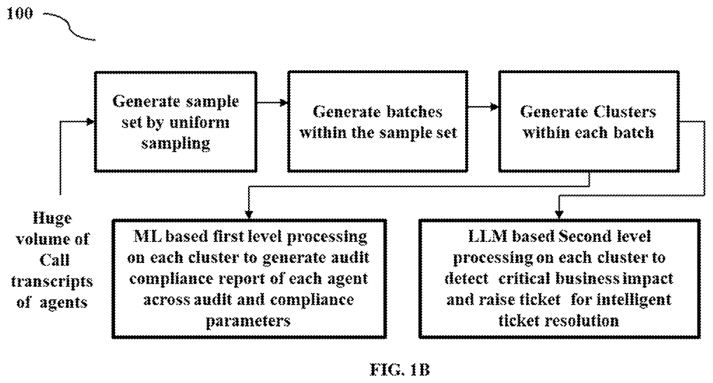

Referring now to the drawings, and more particularly to FIGS. 1A through 4, where similar reference characters denote corresponding features consistently throughout the figures, there are shown preferred embodiments, and these embodiments are described in the context of the following exemplary system and/or method.

FIG. 1A is a functional block diagram of a system 100 Artificial Intelligence (AI) infused call audit and compliance, in accordance with some embodiments of the present disclosure.

In an embodiment, the system 100 includes a processor(s) 104, communication interface device(s), alternatively referred as input/output (I/O) interface(s) 106, and one or more data storage devices or a memory 102 operatively coupled to the processor(s) 104. The system 100 with one or more hardware processors is configured to execute functions of one or more functional blocks of the system 100.

Referring to the components of system 100, in an embodiment, the processor(s) 104, can be one or more hardware processors 104. In an embodiment, the one or more hardware processors 104 can be implemented as one or more microprocessors, microcomputers, microcontrollers, digital signal processors, central processing units, state machines, logic circuitries, and/or any devices that manipulate signals based on operational instructions. Among other capabilities, the one or more hardware processors 104 are configured to fetch and execute computer-readable instructions stored in the memory 102. In an embodiment, the system 100 can be implemented in a variety of computing systems including laptop computers, notebooks, hand-held devices such as mobile phones, workstations, mainframe computers, servers, and the like.

The I/O interface(s) 106 can include a variety of software and hardware interfaces, for example, a web interface, a graphical user interface and the like and can facilitate multiple communications within a wide variety of networks N/W and protocol types, including wired networks, for example, LAN, cable, etc., and wireless networks, such as WLAN, cellular and the like. In an embodiment, the I/O interface(s) 106 can include one or more ports for connecting to a number of external devices or to another server or devices.

For example, a plurality of call transcripts of an organization are sourced via the I/O interface 106 from external sources. The call transcripts are associated with call recordings of a plurality of calls handled by a plurality of agents of an organization with a plurality of customers for a plurality of products. Similarly, the audit and compliance report generated for every call agent and recommendations for critical business impact are displayed to end observer over a display screen of the I/O interface.

The memory 102 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

In an embodiment, the memory 102 includes a plurality of modules 110 such as modules for execution of clustering techniques, pretrained ML models, LLMs etc. Further, the plurality of modules 110 include programs or coded instructions that supplement applications or functions performed by the system 100 for executing different steps involved in the process of Artificial Intelligence (AI) infused call audit and compliance, being performed by the system 100. The plurality of modules 110, amongst other things, can include routines, programs, objects, components, and data structures, which performs particular tasks or implement particular abstract data types. The plurality of modules 110 may also be used as, signal processor(s), node machine(s), logic circuitries, and/or any other device or component that manipulates signals based on operational instructions. Further, the plurality of modules 110 can be used by hardware, by computer-readable instructions executed by the one or more hardware processors 104, or by a combination thereof. The plurality of modules 110 can include various sub-modules (not shown).

Further, the memory 102 may comprise information pertaining to input(s)/output(s) of each step performed by the processor(s) 104 of the system100 and methods of the present disclosure.

Further, the memory 102 includes a database 108. The database (or repository) 108 may include a plurality of abstracted pieces of code for refinement and data that is processed, received, or generated as a result of the execution of the plurality of modules in the module(s) 110. The database 108 stores received call transcripts, sample set derived from the received call transcripts and the batches generated withing the sample set that are processed one by one for call quality analysis.

Although the data base 108 is shown internal to the system 100, it will be noted that, in alternate embodiments, the database 108 can also be implemented external to the system 100, and communicatively coupled to the system 100. The data contained within such external database may be periodically updated. For example, new data may be added into the database (not shown in FIG. 1A) and/or existing data may be modified and/or non-useful data may be deleted from the database. In one example, the data may be stored in an external system, such as a Lightweight Directory Access Protocol (LDAP) directory and a Relational Database Management System (RDBMS). Functions of the components of the system 100 are now explained with reference to steps in flow diagrams in FIG. 1B through FIG. 3.

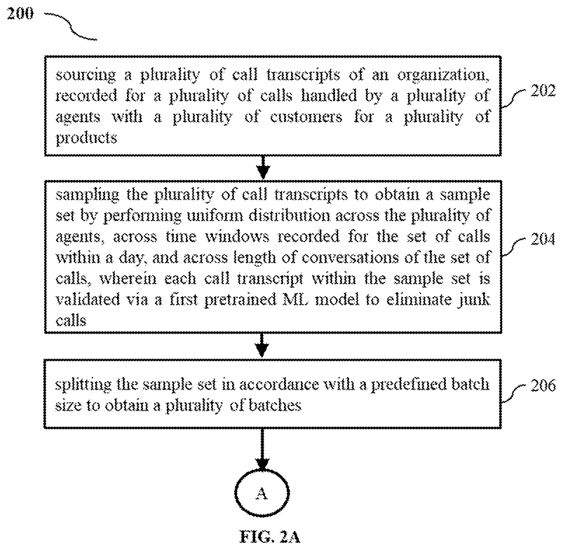

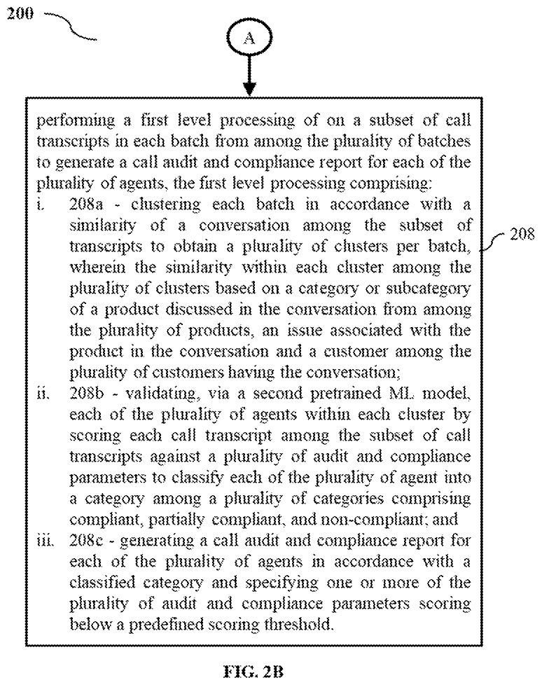

FIG. 1B illustrates an architectural overview of the system FIG. 1A depicting overall process flow, in accordance with some embodiments of the present disclosure. FIG. 1B can be understood in conjunction with method steps of FIGS. 2A and 2B.

FIGS. 2A and 2B is a flow diagram illustrating a method 200 for AI infused call audit and compliance, using the system depicted in FIGS. 1A and 1B, in accordance with some embodiments of the present disclosure.

In an embodiment, the system 100 comprises one or more data storage devices or the memory 102 operatively coupled to the processor(s) 104 and is configured to store instructions for execution of steps of the method 200 by the processor(s) or one or more hardware processors 104. The steps of the method 200 of the present disclosure will now be explained with reference to the components or blocks of the system 100 as depicted in FIGS. 1A and 1B and the steps of flow diagram as depicted in FIGS. 2A and 2B. Although process steps, method steps, techniques or the like may be described in a sequential order, such processes, methods, and techniques may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

Referring to the steps of the method 200, at step 202 of the method 200, the one or more hardware processors 104 are configured by the instructions to source a plurality of call transcripts of an organization, which are recorded for a plurality of calls handled by a plurality of agents with a plurality of customers for a plurality of products. Existing third party services may be used to generate the call transcripts for the call records. Every call transcript has three parts. First part is metadata, second part in the conversation and the third aspect is speaker information. While the system receives transcripts they are processed, and the metadata is read and all the conversations across products, issues and other parameters are grouped for individual agents. This is used to derive further insights in terms of call analysis and agent performance/compliance across variety of parameters.

At step 204 of the method 200, the one or more hardware processors 104 are configured by the instructions to sample the plurality of call transcripts to obtain a sample set by performing uniform distribution across the plurality of agents, across time windows recorded for the set of calls within a day, and across length of conversations of the set of calls. This uniform distribution enables optimal sample section that has all variations withing call records in context of different aspects.

Each call transcript within the sample set is validated via a first pretrained ML model to eliminate junk calls. The junk calls can be defined as calls with less than one minute duration, calls dialed by mistake, calls where customer authentication has failed. The filtering out of junk calls further improvs the sample quality for effective call quality analysis. There are set of business rules defined and configured in the system 100. These rules are given priorities and weightage. All the transcripts are validated against these business rules failing which the call can be categorized as spam or junk. Any one among a plurality of ML models can be used for detecting junk calls, for example XGBoost, Random Forest, Naive Bayes, XSGD Classifier and the like.

At step 206 of the method 200, the one or more hardware processors 104 are configured by the instructions to split the sample set in accordance with a predefined batch size to obtain a plurality of batches. The batch size is a configurable parameter which is typically set based on 1) Number of transcripts received each day, and 2) Nature of transcripts. e.g. If 1000 transcripts are received in a day, the optimum batch size will be 100. This helps in processing the entire dataset in 10 calls instead of 1000 calls if we process it one by one. This significantly helps in processing time & application performance

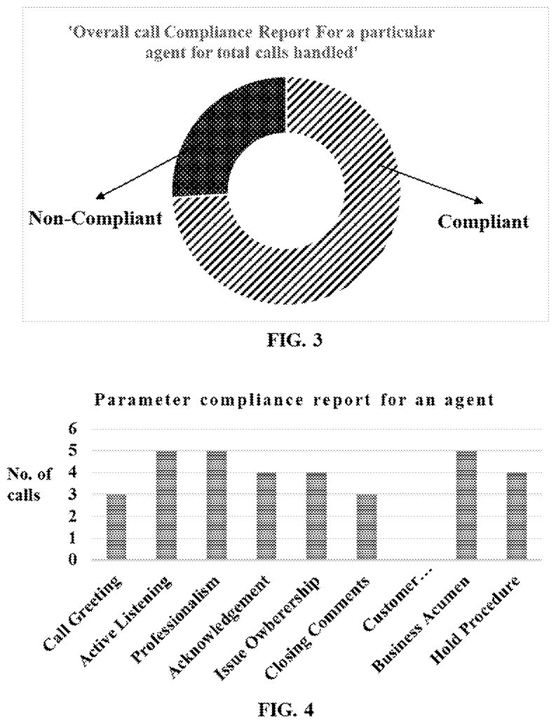

At step 208 of the method 200, the one or more hardware processors 104 are configured by the instructions to perform a first level processing of on a subset of call transcripts in each batch from among the plurality of batches to generate a call audit and compliance report for each of the plurality of agents. The steps of the first level processing include:
1. Step 208 a—Clustering each batch in accordance with a similarity of a conversation among the subset of transcripts to obtain a plurality of clusters per batch. The similarity within each cluster among the plurality of clusters is identified in context of a category or subcategory of a product discussed in the conversation from among the plurality of products, an issue associated with the product in the conversation and a customer among the plurality of customers having the conversation. E.g. The calls are clustered across
   a. Agent who was assigned the call
   b. Issue the agent has addressed (e.g. A particular product, Issue type etc.)
   c. Line of business the call was made
   d. Length of call
   e. Time of call
These unique distribution of parameters helps in intelligently analyzing the calls and also analyze how the issues are being addressed. Also, unique distribution helps in identifying which are the most recurring problems across products, issues, agents etc.
2. Step 208 b—Validating, via a second pretrained ML model, each of the plurality of agents within each cluster by scoring each call transcript among the subset of call transcripts against a plurality of audit and compliance parameters to classify each of the plurality of agent into a category among a plurality of categories comprising compliant, partially compliant, and non-compliant. The plurality of audit and compliance parameters comprise call greeting, customer authentication, business and technical knowledge, time to resolve, and closing notes of each of the plurality of agents and the like. Additional parameters can also be defined for the call transcript being evaluated.
Any among a plurality of ML models can be used for this task (e.g. XGBoost, Random Forest, Naive Bayes, XSGD Classifier). These are multi class classification models where output is generated for various compliance categories like Call Greeting, Customer Experience, Client Authentication, Risk assessment Technical and Business Knowledge etc.
Each of the defined/configured parameters are given weightage and priorities and is configured with the set of business rules. Scores for each parameters are calculated based on the compliance against each of the defined rules. For. e.g. score of 10 is given if all the rules are passed positive, partial compliance would result in a score of 5 and non-compliance would result in score of zero
3. Step 208c—Generating a call audit and compliance report for each of the plurality of agents in accordance with a classified category and specifying one or more of the plurality of audit and compliance parameters scoring below a predefined scoring threshold. The call audit and compliance report and the flag indicating critical business impact is provided to an observer on dashboard via a User Interface (UI) Screen as shown in example screen shot of FIG. 3 and FIG. 4.

Simultaneously for the clusters being created the method 100 also performs a second level processing of each batch to assess critical impact of each call transcript on a business of the organization. The steps for the second level processing include:
1. Summarizing each call transcript of each cluster via a LLM into a call summary to identify meeting topic, key points discussed and generate future recommendations along with overall call sentiments.
2. Processing the call summary of each of the call transcript of associated cluster among the plurality of clusters via the LLM to review and categorize the call summary for assessing critical impact on the business on the category or the sub-category of the product.
   One LLM for Summarisation (GPT™) and the other for creating embedding (ada™).
   Example prompt:
   ‘topic’: ″″″ Topic of the discussion must be in less than five words ″″″,
   ‘problem’: ″″″
      Problems: Problems they discuss
      Bullet point format
   Separate each bullet point with a new line
   ″″″,
   ‘action’: ″″″
      Solution/Action: Return the Solution or next course of action
      Bullet point format
   Separate each bullet point with a new line
   ″″″,
   ‘summary’: ″″″
   Detailed summary of the discussion
3. Raising a flag if assessment indicates critical impact on the business on validation against a set of business rules. Further a ticket can be raised automatically and which is resolved by an intelligent ticket resolving system along with recommendations to reduce and resolve the business impact, The system 100 can be integrated with any of the leading Information technology service management (ITSM) systems like ServiceNow, Remedy etc. where the ticket can be generated by calling the respective API's of ITSM product.
4. Once the ticket is raised in ITSM system, further monitoring and closure of the ticket is handled with ITSM system. The LLM is used to create the summary of the transcript. These summaries have the details around the problem discussed and the resolution provided. The cases where business/legal impact are there will be hidden inside the generated summary. LLM and machine learning models are used to extract those hidden insights and classify them under the appropriate categories.

With use of AI models such as conventional ML models and Large Language Models (LLMs), the method and system disclosed provides time efficient and scalable approach for call audit and compliance analysis for continuous flow of huge volumes of call recordings. The call audit and compliance report generated across a set of call quality parameters per individual (call agent) at frequent intervals enables comparison and recommendation to the individual for performance improvement.

The method and system disclosed herein provides comprehensive agent call compliance and Audit on the entire call data. The method performs call quality and audit is performed across variety of parameters, configurable rating and scores for each of the parameters as per customer charter, complete traceability of the audit parameters using a graph model to link and predicting the missing links, report dashboards giving details of individual/overall compliance and Tech stack leveraged using Python 3.10, Django, MS SQL Server, ChatGPT3.5 Turbo/BERT, Graph DB (NetworkX).

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

It is to be understood that the scope of the protection is extended to such a program and in addition to a computer-readable means having a message therein; such computer-readable storage means contain program-code means for implementation of one or more steps of the method, when the program runs on a server or mobile device or any suitable programmable device. The hardware device can be any kind of device which can be programmed including e.g. any kind of computer like a server or a personal computer, or the like, or any combination thereof. The device may also include means which could be e.g. hardware means like e.g. an application-specific integrated circuit (ASIC), a field-programmable gate array (FPGA), or a combination of hardware and software means, e.g. an ASIC and an FPGA, or at least one microprocessor and at least one memory with software processing components located therein. Thus, the means can include both hardware means, and software means. The method embodiments described herein could be implemented in hardware and software. The device may also include software means. Alternatively, the embodiments may be implemented on different hardware devices, e.g. using a plurality of CPUs.

The embodiments herein can comprise hardware and software elements. The embodiments that are implemented in software include but are not limited to, firmware, resident software, microcode, etc. The functions performed by various components described herein may be implemented in other components or combinations of other components. For the purposes of this description, a computer-usable or computer readable medium can be any apparatus that can comprise, store, communicate, propagate, or transport the program for use by or in connection with the instruction execution system, apparatus, or device.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

What is claimed is:

1. A processor implemented method for call audit and compliance, the method comprising:
sourcing, via one or more hardware processors, a plurality of call transcripts of an organization, recorded for a plurality of calls handled by a plurality of agents with a plurality of customers for a plurality of products;
sampling, via the one or more hardware processors, the plurality of call transcripts to obtain a sample set by performing uniform distribution across the plurality of agents, across time windows recorded for the set of calls within a day, and across length of conversations of the set of calls, wherein each call transcript within the sample set is validated via a first pretrained ML model executed by the one or more hardware processors, to eliminate junk calls;
splitting, via the one or more hardware processors, the sample set in accordance with a predefined batch size to obtain a plurality of batches; and
performing, via the one or more hardware processors, a first level processing of on a subset of call transcripts in each batch from among the plurality of batches to generate a call audit and compliance report for each of the plurality of agents, the first level processing comprising:
clustering, each batch in accordance with a similarity of a conversation among the subset of transcripts to obtain a plurality of clusters per batch, wherein the similarity of conversation is identified in context of a category or subcategory of a product discussed in the conversation from among the plurality of products, an issue associated with the product in the conversation and a customer among the plurality of customers having the conversation;
validating, via a second pretrained ML model executed by the one or more hardware processors, each of the plurality of agents within each cluster by scoring each call transcript among the subset of call transcripts against a plurality of audit and compliance parameters to classify each of the plurality of agent into a category among a plurality of categories comprising compliant, partially compliant, and non-compliant; and
generating, a call audit and compliance report for each of the plurality of agents in accordance with a classified category and specifying one or more of the plurality of audit and compliance parameters scoring below a predefined scoring threshold.

2. The processor implemented method of claim 1, the method comprising performing a second level processing of each batch to assess critical impact of each call transcript on a business of the organization by:
summarizing each call transcript of each cluster via a LLM into a call summary to identify meeting topic, key points discussed and generate future recommendations along with overall call sentiments;
processing the call summary of each of the call transcript of associated cluster among the plurality of clusters via the LLM to review and categorize the call summary for assessing critical impact on the business on the category or the sub-category of the product; and
raising a flag if assessment indicates critical impact on the business on validation against a set of business rules.

3. The processor implemented method of claim 2, wherein the call audit and compliance report and the flag is provided to an observer on dashboard via a User Interface (UI) Screen.

4. The processor implemented method of claim 1, wherein the junk calls are calls with less than one minute duration, calls dialed by mistake, calls where customer authentication has failed.

5. The processor implemented method of claim 1, wherein the plurality of audit and compliance parameters comprise call greeting, customer authentication, business and technical knowledge, time to resolve, and closing notes of each of the plurality of agents.

6. A system for call audit and compliance, the system comprising:
a memory storing instructions;
one or more Input/Output (I/O) interfaces; and
one or more hardware processors coupled to the memory via the one or more I/O interfaces, wherein the one or more hardware processors are configured by the instructions to:
source a plurality of call transcripts of an organization, recorded for a plurality of calls handled by a plurality of agents with a plurality of customers for a plurality of products;
sample the plurality of call transcripts to obtain a sample set by performing uniform distribution across the plurality of agents, across time windows recorded for the set of calls within a day, and across length of conversations of the set of calls, wherein each call transcript within the sample set is validated via a first pretrained ML model executed by the one or more hardware processors, to eliminate junk calls;
split the sample set in accordance with a predefined batch size to obtain a plurality of batches; and
perform a first level processing of on a subset of call transcripts in each batch from among the plurality of batches to generate a call audit and compliance report for each of the plurality of agents, the first level processing comprising:
clustering each batch in accordance with a similarity of a conversation among the subset of transcripts to obtain a plurality of clusters per batch, wherein the similarity of the conversation is identified in context of a category or subcategory of a product discussed in the conversation from among the plurality of products, an issue associated with the product in the conversation and a customer among the plurality of customers having the conversation;
validating via a second pretrained ML model executed by the one or more hardware processors, each of the plurality of agents within each cluster by scoring each call transcript among the subset of call transcripts against a plurality of audit and compliance parameters to classify each of the plurality of agent into a category among a plurality of categories comprising compliant, partially compliant, and non-compliant; and
generating a call audit and compliance report for each of the plurality of agents in accordance with a classified category and specifying one or more of the plurality of audit and compliance parameters scoring below a predefined scoring threshold.

7. The system of claim 6, the method comprising performing a second level processing of each batch to assess critical impact of each call transcript on a business of the organization by:
summarizing each call transcript of each cluster via a LLM into a call summary to identify meeting topic, key points discussed and generate future recommendations along with overall call sentiments;
processing the call summary of each of the call transcript of associated cluster among the plurality of clusters via the LLM to review and categorize the call summary for assessing critical impact on the business on the category or the sub-category of the product; and
raising a flag if assessment indicates critical impact on the business on validation against a set of business rules.

8. The system of claim 7, wherein the call audit and compliance report and the flag is provided to an observer on dashboard via a User Interface (UI) Screen.

9. The system of claim 6, wherein the junk calls are calls with less than one minute duration, calls dialed by mistake, calls where customer authentication has failed.

10. The system of claim 6, wherein the plurality of audit and compliance parameters comprise call greeting, customer authentication, business and technical knowledge, time to resolve, and closing notes of each of the plurality of agents.

11. One or more non-transitory machine-readable information storage mediums comprising one or more instructions which when executed by one or more hardware processors cause:
sourcing a plurality of call transcripts of an organization, recorded for a plurality of calls handled by a plurality of agents with a plurality of customers for a plurality of products;
sampling the plurality of call transcripts to obtain a sample set by performing uniform distribution across the plurality of agents, across time windows recorded for the set of calls within a day, and across length of conversations of the set of calls, wherein each call transcript within the sample set is validated via a first pretrained ML model executed by the one or more hardware processors, to eliminate junk calls;
splitting the sample set in accordance with a predefined batch size to obtain a plurality of batches; and
performing a first level processing of on a subset of call transcripts in each batch from among the plurality of batches to generate a call audit and compliance report for each of the plurality of agents, the first level processing comprising:
clustering, each batch in accordance with a similarity of a conversation among the subset of transcripts to obtain a plurality of clusters per batch, wherein the similarity of conversation is identified in context of a category or subcategory of a product discussed in the conversation from among the plurality of products, an issue associated with the product in the conversation and a customer among the plurality of customers having the conversation;
validating, via a second pretrained ML model executed by the one or more hardware processors, each of the plurality of agents within each cluster by scoring each call transcript among the subset of call transcripts against a plurality of audit and compliance parameters to classify each of the plurality of agent into a category among a plurality of categories comprising compliant, partially compliant, and non-compliant; and
generating, a call audit and compliance report for each of the plurality of agents in accordance with a classified category and specifying one or more of the plurality of audit and compliance parameters scoring below a predefined scoring threshold.

12. The one or more non-transitory machine readable information storage mediums of claim 11, the method comprising performing a second level processing of each batch to assess critical impact of each call transcript on a business of the organization by:
summarizing each call transcript of each cluster via a LLM into a call summary to identify meeting topic, key points discussed and generate future recommendations along with overall call sentiments;
processing the call summary of each of the call transcript of associated cluster among the plurality of clusters via the LLM to review and categorize the call summary for assessing critical impact on the business on the category or the sub-category of the product; and
raising a flag if assessment indicates critical impact on the business on validation against a set of business rules.

13. The one or more non-transitory machine readable information storage mediums of claim 12, wherein the call audit and compliance report and the flag is provided to an observer on dashboard via a User Interface (UI) Screen.

14. The one or more non-transitory machine readable information storage mediums of claim 11, wherein the junk calls are calls with less than one minute duration, calls dialed by mistake, calls where customer authentication has failed.

15. The one or more non-transitory machine readable information storage mediums of claim 11, wherein the plurality of audit and compliance parameters comprise call greeting, customer authentication, business and technical knowledge, time to resolve, and closing notes of each of the plurality of agents.
